(19) United States
(12) Patent Application Publication
(10) Pub. No.: US 2026/0324542 A1
(43) Pub. Date: Oct. 22, 2026

(54) Aerated Grassland Soil Loosening and Fertilization Assembly

(71) Applicant: China Agricultural University, Beijing (CN)

(72) Inventors: Guanghui WANG, Beijing (CN); Cuiqiang YAN, Beijing (CN); Chaoyi ZOU, Beijing (CN); Yingjun ZHANG, Beijing (CN); Xinhao YU, Beijing (CN); Jianjun WANG, Beijing (CN); Junkang LI, Beijing (CN)

(73) Assignee: China Agricultural University, Beijing (CN)

(21) Appl. No.: 19/653,261

(22) Filed: Apr. 21, 2026

(30) Foreign Application Priority Data
Apr. 21, 2025 (CN) 202510496238.6

(51) Int. Cl. A01C 23/02; A01B 45/02; A01B 49/06; A01C 21/00

(52) U.S. Cl. CPC A01C 23/026; A01B 45/026; A01B 49/065; A01C 21/002

(57) ABSTRACT

The present invention relates to an aerated grassland soil loosening and fertilization assembly, which dynamically integrates soil loosening and fertilization during grassland crop planting. Combined with agricultural machinery, grassland planting efficiency is improved and crop germination rates increased. The device comprises a support mechanism, an aeration device, and an air and fertilizer supply device. The support mechanism comprises a support plate, a curved guide rail, and at least one sliding block; the aeration device comprises an aeration pin support and an aeration pin; the air and fertilizer supply device comprises an air pump, an air ring, an air pipe, a fertilizer bin, a fertilizer delivery pipe, and proximity switches.

### INCORPORATION BY REFERENCE

This application claims priority to China Patent Application Number 202510496238.6 filed Apr. 21 2025, the contents of which are hereby incorporated by reference in their entirety.

### Technical Field

The present invention belongs to the technical field of grassland agricultural machinery, specifically an innovative agricultural device combining soil treatment and planting operations, relating to an aerated grassland soil loosening and fertilization assembly.

### Background Technology

With the continuous degradation of grassland ecosystems, soil compaction and fertility decline have become key issues restricting the sustainable development of grasslands. Under the combined effects of long-term natural factors (such as drought and freeze-thaw cycles) and human activities (such as overgrazing and mechanical compaction), the surface soil structure of grasslands has become severely hardened, with a significant increase in bulk density, leading to a significant reduction in soil aeration, permeability, and microbial activity. The decrease in permeability and organic matter contents caused by soil compaction directly weakens the root development capacity and nutrient absorption efficiency of forage grasses. Furthermore, the traditional separated operation mode of loosening soil and fertilization further exacerbates this problem: while conventional disc harrows, subsoilers, and other agricultural machinery can be used to loosen soil, their large-scale tillage easily damages the original sod layer, causing soil erosion and a decrease in vegetation coverage, especially in ecologically fragile areas where it may lead to irreversible grassland desertification.

While with current aeration and loosening technologies soil permeability can be improved by localized punctures, significant bottlenecks remain due to the limited functionality and structural defects of the equipment. For example, traditional aeration equipment often employs manual drilling or intermittent hydraulic operations, generally lacking continuous operation capabilities. Frequent shutdowns for blade cleaning or fertilizer replenishment severely restrict the efficiency of mechanized grassland management on a large scale. The step-by-step loosening and fertilization process not only increases operating costs (fuel consumption increases by 20%-30%) but also creates secondary soil compaction due to repeated mechanical compaction, forming a vicious cycle of "remediation-degradation."

Therefore, there is an urgent need to develop a highly efficient composite equipment integrating loosening, aeration, and precision fertilization functions. This equipment should overcome the limitations of continuous operation through innovative structural design, achieving synergistic soil physical structure improvement and fertility while minimizing turf damage, providing reliable technical support for the ecological restoration of degraded grasslands.

### SUMMARY OF THE INVENTION

The present invention addresses the problems of existing grassland improvement machinery, such as limited operational functions, high soil disturbance intensity, and inability to simultaneously achieve soil loosening, aeration, and precise fertilization. An aerated grassland loosening and fertilization assembly is proposed. Through innovative structural design and functional integration, automated soil aeration, loosening, and fertilization are achieved, realizing the synergistic operation of soil physical structure restoration and fertility enhancement.

To achieve the above objectives, the present invention provides the following technical solution:

An aerated grassland loosening and fertilization assembly comprising a support mechanism, an aeration device and an air and fertilizer supply device;

the support mechanism comprising a support plate, a curved guide rail and at least one sliding block, the curved guide rail being located on an outer edge of the support plate and comprising a slide rail, a drive wheel and a drive chain; the at least one sliding block being mounted on the slide rail via at least one slider pulley and bolted to the drive chain on an inner side thereof, and the drive wheel meshing with the guide rail track;

the aeration device comprising an aeration pin support and an aeration pin, the aeration pin support being fixedly connected to the at least one sliding block and the aeration pin being threadedly connected to the aeration pin support; and the air and fertilizer supply device comprising an air pump, an air ring, an air pipe, a fertilizer bin, a fertilizer delivery pipe, proximity switches and a material tank, the air pump and material tank being located at a central portion of the agricultural machinery, the air ring being located at a central portion of the support plate, the support plate having an opening at a bottom portion of the air ring near the air inlet, one end of the air pipe connecting to the air outlet of the air ring and another end connecting to the air inlet, one end of the fertilizer delivery pipe connecting to a fertilizer outlet and another end connecting to the fertilizer inlet, and the proximity switches being installed on the slide rail.

Preferably, the at least one sliding block is bolted to the drive chain and is detachable and an appropriate number of the at least one sliding block and corresponding spacing are selected based on a aeration range, actual soil hardness of the grassland, growth requirements of sown crops, and a forward speed of the agricultural machinery, allowing for soil aeration tailored to local conditions.

Preferably, the aeration pin support and the aeration pin are connected by threads, facilitating disassembly and replacement of the aeration pin, suitable aeration pins are selected according to different soil conditions and crop needs, furthermore, the aeration pins can be removed during agricultural machinery transportation when soil loosening is not required, without affecting the normal movement of the agricultural machinery.

Preferably, the at least one sliding block has a curved groove, and the aeration pin support has a support pin that passes through the groove and is connected to the at least one sliding block. By moving the support pin and tightening it, the aeration pin support and the at least one sliding block can form different angles, allowing the aeration pins to enter the ground at different angles.

Preferably, the air pump is powered by electricity from a motor, and compressed gas is supplied to the air ring through an air supply pipe, while a pressure regulator valve is installed on the air supply pipe to supply gas at a certain pressure to the material tank, ensuring continuous supply of fertilizers to the fertilizer bin, the air ring is bolted to a geometric center of the curved guide rail and supplies air to the aeration pin through a vent pipe, the proximity switches are installed on the slide rail near the ground, when at least one sliding block passes a front switch, the aeration valve is activated to start aeration, when it passes a rear switch, the aeration valve is activated to stop aeration, the track is relatively stationary in contact with the ground, and the aeration pins complete aeration during this period of relative stillness.

Preferably, a roller-shaped fertilizer bin is installed on a rotor of the air ring outside the air ring, fertilizers inside the box enters the fertilizer inlet through the fertilizer outlet and the fertilizer delivery pipe due to gravity thereof, using the aforementioned delivery device, the fertilizers are added to the aeration pins and injected into the soil along with the gas through the aeration pins, looser soil facilitates fertilizer entry and penetration, thus promoting crop growth and simplifying the fertilization process to some extent.

The grassland aeration and loosening device of the present invention is installed on tracks of a grassland sowing machine via the aforementioned support plate. The drive shaft synchronizes a rotation velocity of the sowing machine, achieving soil loosening and fertilization during the sowing machine's movements.

Compared with existing technologies, the beneficial effects of the present invention are:
1. Through combination of chains, guide rails, and aeration pins, dynamic aeration, loosening, and fertilization are achieved during the agricultural machinery's movement while maintaining the fertilization spacing.
2. The threaded connection design of the pins and pin supports enables pin replacement; the sliding groove design allows for diverse pin insertion angles to adapt to different soil conditions in different regions.
3. The present invention provides a method for dynamically combining aeration and soil loosening with fertilization, achieving integrated soil loosening and fertilization during the movement of agricultural machinery, which is more conducive to fertilizer penetration into the soil and reduces labor pressure to a certain extent.

### BRIEF DESCRIPTION OF DRAWINGS

FIG. 1 is a schematic diagram of outer structures of a grassland aeration and loosening device of the present invention;

FIG. 2 is a schematic diagram of a local structure of a support mechanism;

FIG. 3 is a schematic diagram of a local structure of an aeration device;

FIG. 4 is a schematic diagram of an air and fertilizer supply device;

FIG. 5 is a locally enlarged sectional view of an aeration pin;

FIG. 6 is a structural schematic diagram of tractor equipment; and

FIG. 7 is a structural schematic diagram of an air pump and a material box;

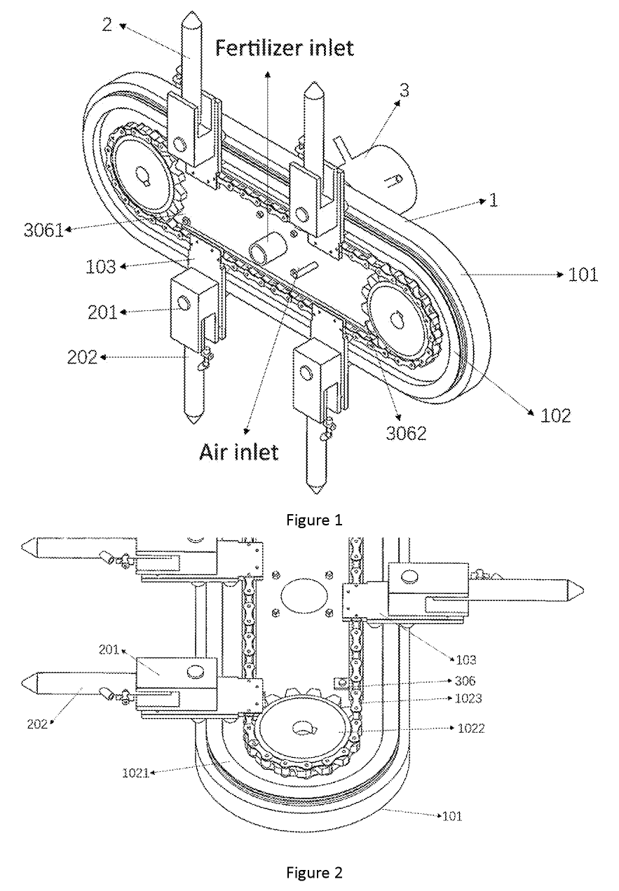

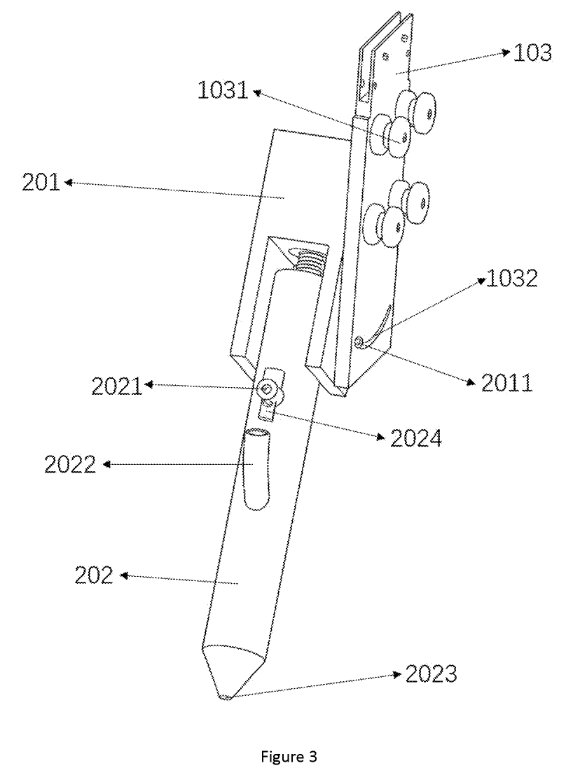

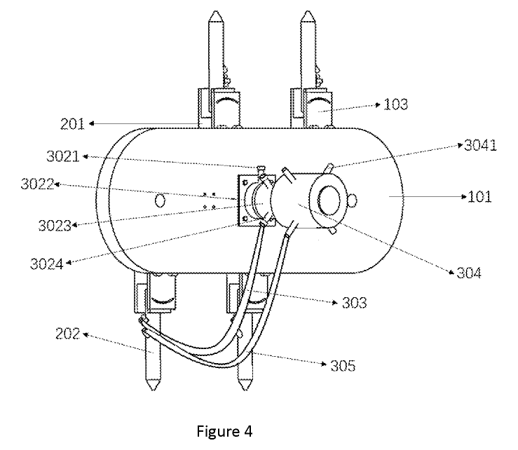

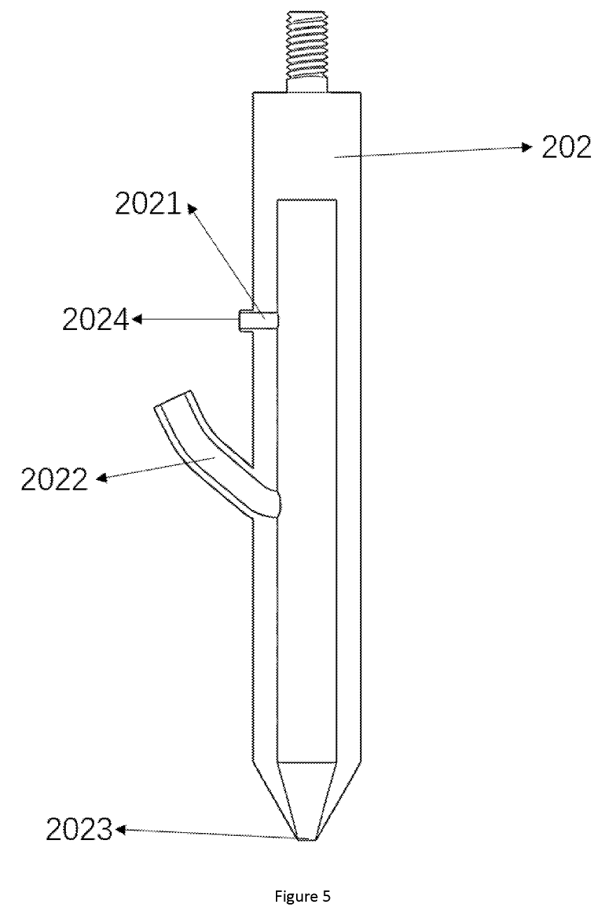

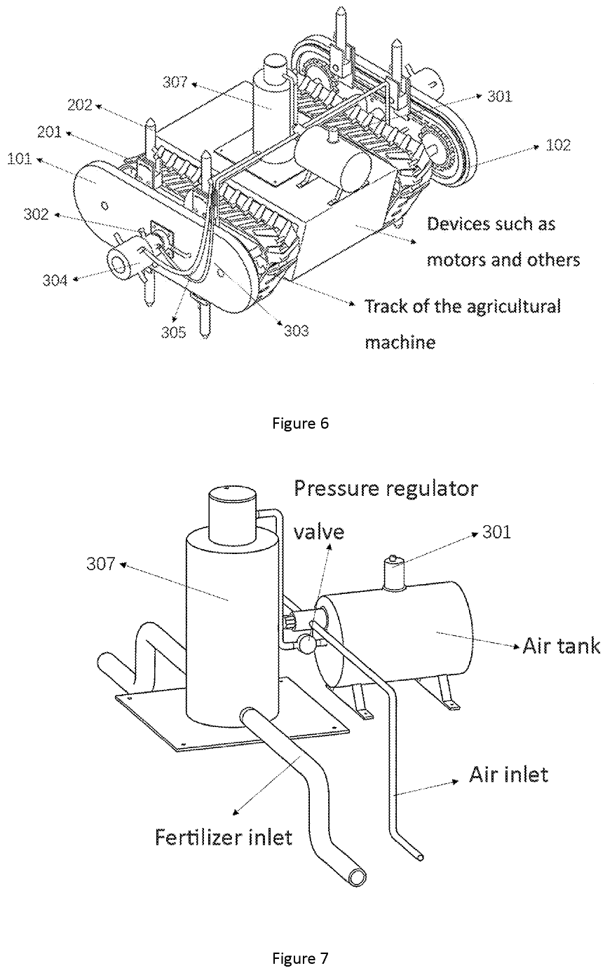

The labels in the drawings are as follows:
1. support mechanism;
   101. support plate;
   102. curved guide rail;
   1021. slide rail;
   1022. drive wheel;
   1023. drive chain;
   103. sliding block;
   1031. slider pulley;
   1032. slide groove;
2. aeration device;
   201. aeration pin support;
   2011. support sliding pin;
   202. aeration pin;
   2021. air inlet;
   2022. fertilizer inlet;
   2023. aeration port;
   2024. aeration valve;
3. air and fertilizer supply device;
   301. air pump;
   302. air ring;
   3021. air ring inlet;
   3022. air ring stator;
   3023. air ring rotor;
   3024. air ring outlet;
   303. ventilation pipe;
   304. fertilizer bin;
   3041. fertilizer outlet;
   305. fertilizer delivery pipe;
   306. proximity switch;
   3061. front switch;
   3062. rear switch; and
   307. material tank;

### DETAILED DESCRIPTION OF THE EMBODIMENTS

The present invention will be further described below with reference to the accompanying drawings and specific embodiments:

Embodiment 1: Referring to the accompanying drawings, an aerated grassland soil loosening and fertilization assembly comprising a support mechanism 1, on which an aeration device 2 and an air and fertilizer supply device 3 are provided;

The support mechanism 1 comprises a support plate 101, a curved guide rail 102, and at least one sliding block 103. The curved guide rail 102 comprises a slide rail 1021, a drive wheel 1022, and a drive chain 1023, with the drive wheel 1022 meshing with the drive chain 1023. The at least one sliding block 103 comprises at least one slider pulley 1031 and a groove 1032, and the at least one sliding block 103 is fixedly connected to the drive chain 1023. The slide rail 1021 passes through the center of the four at least one slider pulleys 1031, and the at least one sliding block 103 can move on the slide rail 1021 driven by the drive chain 1023. The support plate 101 is welded to the curved guide rail 102 and also serves to support the air and fertilizer supply device 3. The drive wheel 1022 is driven by the drive shaft of the agricultural machinery track, and its rotational speed is controlled to be the same as that of the agricultural machinery drive track. The at least one sliding block 103 serves to support the aeration device 2.

The aeration device 2 mainly comprises an aeration pin support 201 and an aeration pin 202. The aeration pin support 201 is provided with a support slide pin 2011. The aeration pin support 201 is rotatably fixed to the at least one sliding block 103, and the support slide pin 2011 passes through the at least one sliding block 103 via a sliding groove 1032. The support slide pin 2011 can rotate within the sliding groove 1032 and can be tightened for fixation. The aeration pin 202 comprises an air inlet 2021, a fertilizer inlet 2022, an aeration port 2023, and an aeration valve 2024. The fertilizer inlet 2022 is located on the side of the air inlet 2021 closest to the aeration port 2023, the aeration port 2023 is located at the tip of the aeration pin 202, and the aeration valve 2024 is positioned between the fertilizer inlet 2022 and the aeration port 2023.

The air and fertilizer supply device 3 is located on the support mechanism 1 and comprises an air pump 301, an air ring 302, an air pipe 303, a fertilizer bin 304, a fertilizer delivery pipe 305, a proximity switch 306, and a material tank 307. The air ring 302 comprises an air ring inlet 3021, an air ring stator 3022, an air ring rotor 3023, and an air ring outlet 3024. The air ring inlet 3021 is located on the air ring stator 3022 and connected to the air pump 301, while the air ring outlet 3024 is located on the air ring rotor 3022. A ventilation pipe 303 is connected at one end to the air ring outlet 3024 and at another end to the air inlet 2021. The fertilizer bin 304 comprises a fertilizer outlet 3041. The fertilizer bin 304 is fixedly connected to the air ring rotor 3023 and rotates with it. The fertilizer outlet 3041 is located on the fertilizer bin 304. The fertilizer bin 304 rotates with the air ring rotor 3023. A fertilizer delivery pipe 305 is connected at one end to the fertilizer outlet 3041 and at the other end to the fertilizer inlet 2022. The air ring rotor 3023 is driven to rotate via a high-strength vent pipe 303, which in turn drives the rotation of the drum-shaped fertilizer bin 304. The rotational speeds of both are matched with the speed of the at least one sliding block 103. The proximity switch 306 consists of a front switch 3061 and a rear switch 3062. The proximity switch 306 controls opening and closing of the aeration valve 2024. When the at least one sliding block 103 moves to the front switch 3061, the aeration valve 2024 opens, initiating aeration; when it moves to the rear switch 3062, the aeration valve 2024 closes, ending aeration. The air pump 301 and the material tank 307 are located at the center of the agricultural machinery. The air pump 301 is connected to the agricultural machinery generator, which provides power to produce gas that supplies the air ring 302. Simultaneously, the vent pipe is equipped with a pressure regulator valve to provide appropriate air pressure to the material tank 307, ensuring that the fertilizer in the material tank 307 continuously passes through the hollow air ring 302 to reach the fertilizer bin 304.

Working Process: referring to the attached diagram, when using this device, drive a tractor to the designated area and equip it with the soil loosening device.

First, survey the soil in the area to understand its hardness and fertility. Based on the growth needs of the sown crop, select the appropriate type of aeration pin 202. Choose the appropriate number of aeration pins 202 (at least one sliding block 103) and the spacing between them according to requirements. Fix the pin insertion angle by moving and tightening the support pins 2011. Connect the air pipe 303 and the fertilizer delivery pipe 305.

Then, start the tractor and move it forward. The starter motor supplies power to the air pump 301. The air pump 301 supplies high-pressure gas to the air ring 302 and simultaneously provides a certain amount of air pressure to the material tank 307 through the pressure regulator valve, ensuring a continuous flow of fertilizer into the fertilizer bin 304. As the tractor moves forward, the track drive shaft simultaneously drives the drive wheel 1022 in this device to rotate, thereby rotating the drive chain 1023 meshing with the drive wheel 1022, which in turn moves the at least one sliding block 103 bolted to the drive chain 1023. An aeration pin support 201 is fixed on the at least one sliding block 103, and an aeration pin 202 is fixed on the aeration pin support 201. The air inlet 2021 and the fertilizer inlet 2022 on the aeration pin 202 are connected to the air ring rotor 3023 and the fertilizer bin rotor 304 through the air pipe 303 and the fertilizer delivery pipe 305, respectively. When the drive wheel 1022 rotates, the air ring rotor 3023 and the fertilizer bin rotor 304 rotate passively. When the at least one sliding block 103 rotates to the bottom of the fertilizer bin rotor 304, that is, when the aeration pin 202 is inserted into the ground, the fertilizer in the fertilizer bin 304 is affected by gravity and flows from the fertilizer outlet 3041 through the fertilizer delivery pipe 305 into the fertilizer inlet 2022. Simultaneously, when at least one sliding block 103 passes the front switch 3061 (i.e., when the aeration pin 202 is inserted into the soil), the aeration valve 2024 opens. High-pressure gas enters the air inlet 2021 from the air ring outlet 3024 through the air pipe 303, carrying fertilizer entering from the fertilizer inlet 2022 below the air inlet 2021 and exiting through the aeration port 2023. The high-pressure gas and fertilizer enter the soil together, thus completing the aeration process. When at least one sliding block 103 passes the rear switch 3062 (i.e., when the aeration pin 202 is about to leave the soil), the aeration valve 2024 closes, the aeration pin stops aeration, and the fertilizer, affected by gravity, no longer enters the fertilizer delivery pipe. Thereafter, the aeration valve 2024 remains closed, gas no longer enters the aeration pin 202, and the fertilizer, affected by gravity, no longer enters the fertilizer delivery pipe 305. Aeration resumes when at least one sliding block 103 passes the front switch 3061 again, completing the dynamic cycle.

The specific embodiments of the present invention have been described in detail above with reference to the accompanying drawings. However, the present invention is not limited to the above embodiments. Within the scope of knowledge possessed by those skilled in the art, various changes can be made without departing from the spirit of the present invention.

1. An aerated grassland soil loosening and fertilization assembly, comprising a support mechanism (1), an aeration device (2), and an air and fertilizer supply device (3); the support mechanism (1) comprises at least one support plate (101), at least one curved guide rail (102), and at least one sliding block (103); the curved guide rail (102) is located on an outer edge of the at least one support plate (101); the curved guide rail (102) comprises at least one slide rail (1021), at least one drive wheel (1022), and at least one drive chain (1023); the at least one drive wheel (1022) meshes with the at least one drive chain (1023); the at least one sliding block (103) comprises at least one slider pulley (1031) and at least one groove (1032); the at least one sliding block (103) is located on the at least one slide rail (1021) and a bottom portion thereof is bolted to the at least one drive chain (1023); four slider pulleys (1031) are arranged in a rectangular shape and fixedly connected to a bottom portion of the at least one sliding block (103); the at least one slide rail (1021) passes through the at least one slider pulley (1031) to form a rectangular arrangement; the at least one groove (1032) is curved and located in the at least one sliding block (103); the at least one aeration device (2) comprises at least one aeration pin support (201) and at least one aeration pin (202); the at least one aeration pin support (201) is located on the at least one sliding block (103); the at least one aeration pin (202) is threaded to the at least one aeration pin support (201); the at least one aeration pin support (201) comprises at least one support slide pin (2011), which passes through the at least one groove (1032);
the air and fertilizer supply device (3) comprises at least one air pump (301), at least one air ring (302), at least one air pipe (303), at least one fertilizer bin (304), at least one fertilizer delivery pipe (305), and proximity switches (306); the at least one air ring (302) is roller-shaped and comprises at least one air ring inlet (3021), at least one air ring stator (3022), at least one air ring rotor (3023), and at least one air ring outlet (3024); the at least one air ring inlet (3021) is located on a side and connected to the at least one air pump (301); the at least one air ring outlet (3024) is located on the at least one air ring rotor (3023); the at least one fertilizer bin (304) is roller-shaped and comprises at least one fertilizer outlet (3041) located on the at least one fertilizer bin (304); one end of the at least one air pipe (303) is connected to the at least one air ring outlet (3024), and another end thereof is connected to the at least one air inlet (2021); one end of the at least one fertilizer delivery pipe is connected to the at least one fertilizer outlet (3041), and another end is connected to the at least one fertilizer inlet (2022); the proximity switches (306) comprise a front switch (3061) and a rear switch (3062); the proximity switches (306) are located on a straight section of the at least one slide rail (1021);
the at least one air ring (302) is coaxially fixed with the at least one fertilizer bin (304) and rotates synchronously with the at least one air ring rotor (3023); the aerated grassland loosening and fertilizing device is installed on a tracked agricultural machine; the at least one drive wheel (1022) is driven by a track drive shaft of the agricultural machine, and a speed thereof is controlled to be the same as a speed of the track drive shaft of the agricultural machine;
the at least one aeration pin support (201) and the at least one sliding block (103) are rotatably fixed; the at least one support sliding pin (2011) passes through the at least one sliding groove (1032) and can be adjusted in tightness, and can change an angle at which the at least one aeration pin (202) enters the soil;
surveying the soil and selecting an appropriate type of aeration pins according to soil hardness, fertility and growth requirements of sown crops, selecting an appropriate number of aeration pins, namely a number of sliding blocks, and a spacing between each of the aeration pins according to requirements, fixing a soil entry angle of the pin by moving and tightening the support sliding pin;
allowing high-pressure gas to enter the air inlet from the air ring outlet through the air pipe when the aeration pin is inserted into the soil, carrying the fertilizer entering from the fertilizer inlet below the air inlet and discharging through the aeration port, and enabling the high-pressure gas and the fertilizer to enter the soil together to complete aeration.

2. The aerated grassland soil loosening and fertilization assembly according to claim 1, wherein the at least one aeration pin (202) comprises at least one air inlet (2021), at least one fertilizer inlet (2022), at least one aeration port (2023), and at least one aeration valve (2024); the at least one fertilizer inlet (2022) and the at least one air inlet (2021) are arranged on the at least one aeration pin (202), with the at least one fertilizer inlet (2022) being closer to the at least one aeration port (2023); and the at least one aeration valve (2024) is located on the at least one air inlet (2021).

3. The aerated grassland soil loosening and fertilizing device according to claim 2, wherein the air supply and fertilizer supply device (3) is located at a center portion of the at least one support plate (101); when the at least one drive wheel (1022) rotates, the at least one drive chain (1023) meshing with the at least one drive wheel (1022) is driven to rotate, thereby driving the at least one sliding block (103) to rotate, driving the at least one aeration pin (202) to rotate, driving the at least one air ring rotor (3023) and the at least one fertilizer bin (304) connected thereto respectively through the at least one air pipe (303) and at least one the fertilizer delivery pipe (305) to rotate.

4. The aerated grassland soil loosening and fertilizing device according to claim 1, wherein the support plates (101) are vertically suspended outside tracks of the agricultural machine using a shaft of the agricultural machine and are symmetrically arranged; the aeration device (2) is located inside the agricultural machine relative to the air supply and fertilizer supply device (3) and is symmetrically arranged on a left side and a right side of the agricultural machine; and a detachable protective shell is installed outside the support plates (101).

5. The aerated grassland soil loosening and fertilization assembly according to claim 1, wherein the at least one aeration pin (202) and the at least one pin support (201) are connected by threads, allowing for convenient assembly and disassembly; the at least one aeration pin (202) is adjusted as necessary, and the at least one aeration pin (202) can be removed for easy transport of the agricultural machine.

6. The aerated grassland soil loosening and fertilization assembly according to claim 1, wherein the proximity switches (306) are installed on the at least one slide rail (1021) close to the soil; the front switch (3061) and the rear switch (3062) are a certain distance apart, and control opening and closing of the at least one aeration valve
(2024); when the at least one sliding block (103) rotates to the front switch (3061), that is, when the at least one aeration pin (202) on the at least one sliding block (103) is inserted into the soil, the at least one aeration valve (2024) opens, and gas enters the at least one aeration pin (202) to start aeration; when the at least one sliding block (103) rotates to the rear switch (3062), that is, when the at least one aeration pin (202) on the at least one sliding block (103) leaves the soil, the at least one aeration valve (2024) closes, gas no longer enters the at least one aeration pin (202), and aeration ends.
